(19) United States
(12) Patent Application Publication
(10) Pub. No.: US 2009/0017290 A1
(43) Pub. Date: Jan. 15, 2009

(54) Metallised Film Having Good Barrier Properties

(75) Inventors: Joachim Jung, Neunkirchen (DE); Peter Schlachter, Bischmisheim (DE)

Correspondence Address: CONNOLLY BOVE LODGE & HUTZ, LLP, P O BOX 2207, WILMINGTON, DE, 19899, US

(73) Assignee: Treofan Germany GmbH & Co. KG, Neunkirchen (DE)

(21) Appl. No.: 11/574,024

(22) PCT Filed: Jul. 21, 2005
(86) PCT No.: PCT/EP05/53538

§ 371 Date: Feb. 21, 2007

(30) Foreign Application Priority Data
Aug. 25, 2004 (DE) 10 2004 041 359.2

(51) Int. Cl. B32B 15/085; B32B 37/00; B29C 47/02

(52) U.S. Cl. 428/336; 156/60; 264/173.16; 264/469

(57) ABSTRACT

The invention relates to a metallized, biaxially oriented, transparent polypropylene multi-layer film which contains at least two layers, wherein the layers comprise a base layer and at least one first metallized cover layer on a surface of the base layer wherein the layer contains at least 80% by weight of a propylene-ethylene copolymer which has an ethylene content of 1.2 to <2.8% by weight and a propylene content of 97.2-98.8% by weight and a melting point in the region of 140 to 160° C. and a fusion enthalpy of 80 to 110 J/g and the first cover layer has a thickness of at least 2.5 μm and the film is metallized on the surface of the first cover layer.

Metallised film with good barrier properties

The present invention relates to a metallised transparent polypropylene film and its use in laminates as well as to a process for the production of bag packaging from these laminates,

Biaxially oriented polypropylene films (boPP) are nowadays used as packaging films for a wide variety of applications, Polypropylene films are characterised by many advantageous application properties such as high transparency, gloss, water vapour barrier, good printability, rigidity, penetration resistance etc. etc. In spite of this variety of advantageous properties, there are still areas nowadays in which the polypropylene film has to be combined with other materials in order to make up for certain deficiencies. For materials to be packaged that are sensitive to moisture and oxygen, in particular, polypropylene films have so far not been successful as sole packaging material. In the area of packaging of snacks, for example, both the water vapour barrier and the oxygen barrier play a decisive part. In the case of a water absorption of only approximately 3%, potato chips and other snack foods become so sticky that the consumer finds then unpalatable. In addition, the oxygen barrier has to ensure that the fats contained in the snack food do not develop a rancid taste as a result of photooxidation. These requirements are not satisfied by a polypropylene film used as such as packaging material.

It is known that the barrier properties of boPP can be improved by metallising, as a result of which both the permeability to water vapour and oxygen is considerably reduced. As an example, the oxygen permeability of a transparent 20 μm boPP-film can be reduced to approximately 40 cm³/m²*day* bar by metallising and laminating with a further transparent 20 μm film (compare VR Interpack 99 Special D28 “Der gewisse Knack”).

For application for particularly sensitive products, even this barrier of metallised boPP films is insufficient. In those cases, the lamination of a substrate with an aluminium film is preferred. This packaging is much more complicated and expensive than composites of metallised boPP film but, as a result of the lamination with the highly dense aluminium film, they provide an excellent oxygen barrier. Such laminates with aluminium film are, for example, used for so-called packet soups and ready-made sauces (e.g. Maggi-Fix products) and similar packaged products in powder form which, as a result of the high fat content and large surface area of the powder, need to be protected particularly effectively against light and oxygen.

In some applications, boPP films are metallised only with a view to the optical impression. In this case, the consumer is to be given the impression of high-value packaging without a better barrier actually being present. In these cases, the requirements regarding the metallised film are comparatively non-critical. The metallised film needs to exhibit only an even optical aspect and a sufficient metal adhesion.

DE 39 33 695 describes such a non-sealable film consisting of a base layer of polypropylene and at least one top layer which is built up of a special ethylene-propylene copolymer. This copolymer is characterised by an ethylene content of 1.2 to 2.8% by weight and a distribution factor of >10 and a melt enthalpy of >80 J/g and a melt flow index of 3 to 12 g/10 min (21.6N and 230° C.). It is described that the properties of the copolymer need to be kept within these narrow limits in order to improve the printability and the optical properties.

The present invention was based on the task of providing a film with a excellent water vapour and oxygen barrier.

The task on which the invention is based is achieved by way of a metallised, biaxially oriented, transparent polypropylene multi-layered film which comprises a base layer and at least one first cover layer, the first cover layer containing at least 80% by weight of propylene-ethylene copolymer which has an ethylene content of 1.2 to <2.8% by weight and a propylene content of 97.2-98.8% by weight and a melting point in the region of 140 to 160° C. and a fusion enthalpy of 80 to 110 J/g and the first cover layer having a thickness of 0.5-2 μm and the first intermediate layer a thickness of at least 2.5 μm and being metallised on its surface.

The task is also achieved by way of a metallised, biaxially oriented, transparent polypropylene multi-layered film which comprises a base layer and at least one first intermediate layer and a first cover layer, the first cover layer and the first intermediate layer being placed on top of each other and containing at least 80% by weight of propylene-ethylene copolymer respectively which has an ethylene content of 1.2 to <2.8% by weight and a propylene content of 97.2-98.8% by weight and a melting point in the region of 140 to 160° C. and a fusion enthalpy of 80 to 110 J/g and the first cover layer having a thickness of 0.5-2 μm and the first intermediate layer a thickness of at least 2.0 μm and the film being metallised on the external surface of the first cover layer.

Moreover, the task is achieved by laminates produced from these films.

According to the meaning of the present invention, the base layer is that layer of the film which constitutes more than 50%, preferably more than 65% of the total thickness of the film. Intermediate layers are layers which are present between the base layer and a further polyolefin layer. Cover layers form the external layers of the non-metallised coextruded film. Cover layers may be applied directly onto the base layer. Moreover, there are embodiments, in the case of which the cover layer is applied onto the intermediate layer or intermediate layers of the film.

The present invention starts out from the known metallised transparent coextruded films which have a good metal adhesion. It was found, in spite of a good metal adhesion, these known metallised films produce a barrier vis-à-vis water vapour and oxygen which is insufficient for many applications. It was found that the barrier effect of the metallisation can, surprisingly, be improved considerably if the layer thickness of the cover layer to be metallised is increased to at least 2.5 μm and this layer is built up of the propylene-ethylene copolymers defined in greater detail in claim 1 and 2 having a low ethylene content.

This thick layer to be metallised can be achieved by way of a single cover layer of corresponding thickness on the transparent base layer. Advantageously, an intermediate layer can also be combined with a cover layer, the total thickness of intermediate and cover layer needing again to have a minimum thickness of 2.5 μm and, obviously, both layers needing to consist of the said copolymer. This embodiment is particularly flexible regarding the addition of additives since the optional additives for the cover layer and the intermediate layer can be selected independently.

Surprisingly enough, this measure improves the barrier of the transparent film after metallisation considerably even though no special barrier properties can be detected on the non-metallised films. Before the priority date, it had not been known that the thickness of the layer to be metallised can influence the barrier effect of the metal layer. Surprisingly enough, this is the case with propylene copolymers with a low ethylene content even though such an influence of the layer thickness has been detected neither in the case of the structurally closely related propylene homopolymers or the usual propylene copolymers.

The propylene copolymers with a low ethylene content and a high melting point which are used according to the invention in the layer to be metallised are known as such and will be termed “minicopo” in the following in connection with the present invention as a result of their comparatively low ethylene content. Thus different teachings describe the advantageous use of these raw materials. In EP 0 361 280, for example, it is indicated that this material is advantageous as cover layer in the case of metallisable films. DE 39 33 695 described improved adhesion properties of these cover layers. However, it was neither known nor foreseeable that the thickness of this special copolymer cover layer would have a critical effect on the barrier properties after metallising. It was consequently surprising that the barrier is significantly improved with a layer thickness of at least 2.5 μm and more.

For the purposes of the present invention, propylene-ethylene copolymers with an ethylene content of 1.2 to 2.8% by weight, in particular 1.5 to 2.3% by weight, are particularly preferred. Preferably, the melting point is in the region of 145 to 155° C. and the fusion enthalpy preferably in the region of 90 to 100 J/g. The melt flow index generally amounts to 3 to 15 g/10 min, preferably 3 to 9 g/10 min (230° C., 21.6N DIN 53 735).

The cover layer to be metallised and/or the metallised cover layer will be referred to as first cover layer in connection with the present application. In general, the first cover layer contains at least 80% by weight, preferably 95 to 100% by weight, in particular 98 to <100% by weight, of the copolymer described. In addition to this main component, the cover layer may contain the usual additives such as stabilisers and/or neutralising agents in effective quantities in each case. If necessary, small quantities of a second different polyolefin, preferably propylene polymers, may be contained if its proportion is below 20% by weight, preferably below 5% by weight and the metallisability of the layer is not impaired. Such embodiments are not preferred but feasible if, for example, additives are incorporated via concentrates which are based on a different polymer such as e.g. propylene homopolymer or other propylene mixed polymers. With a view to metallising, additives which impair the metallisability should not be contained in the cover layer. This applies, for example, to migrating slips or antistatics. Antiblocking agents may be added, if necessary, to avoid blocking in small quantities.

In a second embodiment according to the invention, the metallisable film comprises a combination of a first cover layer D and a first intermediate layer Z, the first intermediate layer Z being applied between the said first cover layer and the base layer B, i.e. a surface of this intermediate layer is bonded to the base layer and the second layer opposite is bonded to the cover layer, in line with a BZD-construction.

For this embodiment, both layers, the first cover layer and the first intermediate layer, are built up of the same minicopo described above. Both layers contain at least 80% by weight, preferably 95 to 100% by weight, in particular 98 to <100% by weight of the polymer, the exact composition of the individual layers obviously not needing to be identical. These embodiments with a combination of intermediate layer and cover layer are advantageous with a view to the possible addition of different additives to the individual layers. Thus, it is possible, for example, to add selected additives only to the intermediate layer and to keep the cover layer free from other additives. In general, however, both layers will contain stabilisers and neutralising agents.

For the first embodiment described above, the thickness of the first cover layer is generally at least 2.5 μm, preferably 3 to 10 μm, in particular 3.5 to 5 μm. For embodiments with an intermediate layer, these figures apply correspondingly to the total thickness of the intermediate layer and the cover layer, the thickness of the intermediate layer being in general at least 3.0 μm, preferably 3.5-8 μm and the thickness of the cover layer in general 0.5 to 2 μm.

To improve the metal adhesion, the surface of the first cover layer is generally subjected to a process for increasing the surface tension by means of corona, flame or plasma in a manner known as such. Typically, the surface tension of the cover layer thus treated but not yet metallised is then in the region of 35 to 45 mN/m.

The base layer of the multi-layer film contains polyolefin, preferably a propylene polymer, as well as, if necessary, further common additives in effective quantities respectively. In general, the base layer contains at least 85% by weight, preferably 90 to 100% by weight, in particular 95 to <100% by weight of the polyolefin, based on the weight of the layer.

Propylene polymers are preferred as polyols of the base layer. These propylene polymers contain 90 to 100% by weight, preferably 95 to 100% by weight, in particular 98 to 100% by weight, of propylene units and have a melting point of 120° or higher, preferably 150 to 170° C. and in general a melt flow index of 1 to 10 g/10 min, preferably 2 to 8 g/10 min at 230° C. and a force of 21.6 N (DIN 53735). Isotactic propylene homopolymers with an atactic proportion of 15% by weight and less, copolymers of ethylene and propylene with an ethylene content of 5% by weight or less, copolymers of propylene with C₄-C₈-olefins with an olefin content of 5% by weight or less, terpolymers of propylene, ethylene and butylene with an ethylene content of 10% by weight or less and with a butylene content of 15% by weight or less represent preferred propylene polymers for the base layer, isotactic propylene homopolymers being particularly preferred. The weight percentages indicated relate to the polymer concerned.

The overall thickness of the film is generally in the region of 12 to 100 μm, preferably 15 to 60 μm, in particular 17 to 40 μm.

In a further preferred embodiment, the film comprises further layers which are applied on the opposite side of the base layer. A second cover layer results in 3-layer or 4-layer films. Embodiments which additionally have a second intermediate layer and a second cover layer applied thereon lead to 4-layer or 5-layer films. In these embodiments, the thickness of the second cover layer is in general 0.5-3 μm, a second intermediate layer is in the region 1 to 8 μm. Combinations of intermediate layer and cover layer preferably have a total thickness of 2 to 8 μm. Sealable layers are preferred as further layers, which should be understood to mean both heat sealable as well as cold sealable layers.

The additional layer or layers generally contain at least 80% by weight, preferably 90 to <100% by weight of olefinic polymers or mixtures thereof. Suitable polyolefins are, for example, polyethylene, propylene copolymers and/or propylene terpolymers as well as the propylene homopolymers already described in connection with the base layer.

Suitable propylene copolymers or terpolymers of the additional second layers are generally built up of at least 50% by weight propylene and ethylene and/or butylene units as comonomer. Preferred copolymers are random ethylene-propylene copolymers with an ethylene content of 2 to 10% by weight, preferably 5 to 8% by weight or, random propylene-butylene-1-copolymers with a butylene content of 4 to 25% by weight, preferably 10 to 20% by weight, based on the total weight of the copolymer in each case, or random ethylene-propylene-butylene-1-terpolymers with an ethylene content of 1 to 10% by weight, preferably 2 to 6% by weight and a butylene-1-content of 3 to 20% by weight, preferably 8 to 10% by weight, based on the total weight of the terpolymers. These copolymers and terpolymers generally have a melt flow index of 3 to 15 g/10 min, preferably 3 to 9 g/10 min (230° C.), 21.6 N DIN 53735) and a melting point of 70 to 14° C., preferably 90 to 140° C. (DSC).

As mentioned above, all layers of the film preferably contain neutralising agents and stabilisers in effective quantities respectively.

The usual compounds with a stabilising effect can be used as stabilisers for ethylene polymers, propylene polymers and other olefin polymers. The quantities to be added are between 0.05 and 2% by weight. Phenolic stabilisers, alkali stearates/alkaline earth stearates and/or alkali carbonates/alkaline earth carbonates are particularly suitable. Phenolic stabilisers in a quantity of 0.1 to 0.6% by weight, in particular 0.15 to 0.3% by weight, and with a molecular weight of more than 500 g/mole are preferred. Pentaerythritol-tetrakis-3-5(3,5-di-tertiary butyl-4-hydroxyphenyl) propionate or 1,3,5-trimethyl-2,4,6-tris (3,5-di-tertiary butyl-4-hydroxybenzyl) benzene are particularly advantageous.

Neutralising agents preferably consist of calcium stearate and/or calcium carbonate and/or synthetic dihydrotalcite (SHYT) with an average particle size of maximum 0.7 μm, an absolute particle size of less than 10 μm and a specific surface area of at least 40 m²/g. In general, neutralising agents are used in a quantity of 50 to 1000 ppm, based on the layer.

In a preferred embodiment, antiblocking agents are added to the second cover layer.

Suitable antiblocking agents are inorganic additives such as silicon dioxide, calcium carbonate, magnesium silicate, aluminosilicate, calcium phosphate and such like and/or incompatible polymers such as polymethyl methacrylate (PMMA), polyamides, polyesters, polycarbonates and such like, polymethyl methacrylate (PMMA), silicon dioxide and calcium carbonate being preferred, The effective quantity of antiblocking agent is in the region of 0.1 to 2% by weight, preferably 0.1 to 0.5% by weight, based on the cover layer. The average particle size is between 1 and 6 μm, in particular 2 and 5 μm, particles with a spherical form, as described in EP-A-0 236 945 and DE-A-38 01 535, being particularly suitable.

The invention relates moreover to a process for the production of the multi-layer film according to the invention according to a co extrusion process which is known as such, flat film production, in particular the setter process being, preferred.

Within the framework of this process, the melts corresponding to the individual layers of the film are coextruded through a flat die, the film thus obtained is pulled off on one or several rollers for strengthening, the film is subsequently stretched (oriented), the stretched film is heat set and, if necessary, plasma, corona or flame treated on the surface layer intended for treatment.

In detail, the polymer or the polymer mixture of the individual layers is compressed and liquefied in an extruder, as is common practice in the extrusion process, it being possible for additives which may be added, to be already present in the polymer and/or the polymer mixture. As an alternative, the additives can be incorporated via a master batch.

The melts are then pressed jointly and simultaneously through a flat die (slit die) and the pressed multi-layer film is pulled off on one or several take-off rollers at a temperature of 5 to 100° C., preferably 10 to 50° C., while it is cooled and solidifies.

The film thus obtained is stretched longitudinally and transversely to the direction of extrusion, leading to an orientation of the molecule chains. Longitudinal stretching is preferably carried out at a temperature of 80 to 150° C., appropriately by means of two rollers operating at different speeds to correspond to the intended stretching ratio and transverse stretching is preferably carried out at a temperature of 120 to 170° C. by means of a corresponding setter frame. The longitudinal stretch ratios are in the region of 4 to 8, preferably 4.5 to 6. The transverse stretch ratios are in the region of 5 to 10, preferably 7 to 9.

Stretching of the film is followed by heat setting (thermal treatment), the film being maintained for approximately 0.1 to 10 s at a temperature of 100 to 160° C. Subsequently, the films are wound in the usual manner with a winding device.

After biaxial stretching, one or both surface(s) of the film are preferably plasma, corona or flame treated according to one of the known methods. The treatment intensity is generally in the region of 35 to 50 mN/m, preferably 37 to 45 mN/m, in particular 39 to 42 mN/m.

For the alternative corona treatment, the film is passed between two conductor elements serving as electrodes, a voltage of such intensity, usually alternative voltage (10 000 V and 10 000 Hz) being applied between the electrodes that spray or corona discharges are able to take place. As a result of the spray or corona discharge, the air above the film surface is ionised and reacts with the molecules of the film surface such that polar inclusions are formed in the essentially non-polar polymer matrix. The treatment intensities are within the usual framework, 37 to 45 mN/m being preferred.

The coextruded multi-layer film is provided with a metal layer, preferably of aluminium, on the external surface of the first cover layer according to processes known as such. This metallisation takes place in a vacuum chamber in which aluminium is evaporated and precipitated out on the film surface. In a preferred embodiment, the surface to be metallised can be subjected to plasma treatment immediately before metallisation. The film thus metallised can be used directly for the production of packaging.

In a preferred embodiment of the packaging, the metallised film according to the invention is laminated with a further biaxially oriented film, preferably a polypropylene film, lamination taking place on the metallised side of the metallised film. The lamination can take place by extrusion lamination or by adhesive lamination, for example. Preferably, the further boPP film is printed for the packaging to have an attractive appearance. Basically, transparent or opaque boPP films can be used for the further film.

To characterise the raw materials and the films, the following methods of measurement have been used:

Melt Flow Index

The melt flow index was measured according to DIN 53 735 under a load of 21.6 N and at 230° C.

Water Vapour and Oxygen Permeability

The water vapour permeability is determined according to ASTM F 1249. The determination of the oxygen barrier effect takes place according to draft DIN 53 380 part 3 at an atmospheric humidity of 50%

Determination of the Ethylene Content

The ethylene content of the copolymer is determined by means of ¹³C-NMR spectroscopy. The measurements were carried out by means of a nuclear magnetic resonance spectrometer from Broker Advance 360. The copolymer to be characterised is dissolved in tetrachloroethane such that a 10% mixture is formed. Octamethyl tetrasiloxane (OTMS) was added as reference standard. The nuclear magnetic resonance spectrum was measured at 120° C. The evaluation of the spectra took place as described in J. C. Randall Polymer Sequence Distribution (Academic Press, New York, 1977).

Melting Point and Fusion Enthalpy

The determination of the melting point and the fusion enthalpy took place by DSC (differential scanning calorimetry) measurements (DIN 51 007 and DIN 53 765), A few milligram (3 to 5 mg) of the raw material to be characterised are heated in a differential scanning calorimeter at a rate of heating of 20° C. per minute. The heat flow rate is plotted against the temperature and the melting point is determined as the maximum of the melting cure and the fusion enthalpy as surface area of the melt peak concerned.

Surface Tension

The surface tension was determined by means of the ink method according to DIN 53 364.

The invention will now explain by the following examples.

### EXAMPLE 1

According to the coextrusion process, a 3-layer prefilm was extruded from a slit die extrusion at a temperature 240 to 270° C. This prefilm was first pulled off on a chill roll and cooled. Subsequently, the prefilm was oriented in the longitudinal and transverse direction and subsequent heat set. The surface of the first cover layer was pretreated by corona treatment to increase the surface tension. The 3-layer film had a layer structure of first cover layer/base layer/second cover layer. The individual layers of the film had the following composition:

First cover layer (4.0 μm):

100% by weight of ethylene-propylene copolymer with a proportion of ethylene of 1.7% by weight (based on the polymer) and a melting point of 155° C.; and a melt flow index of 8.5 g/10 min at 230° C. and a load of 216 kg (DIN 53 735) and a fusion enthalpy of 96.9 J/g.

Base Layer

100% be weight of propylene homopolymer (PP) with an n-heptane-soluble proportion of approximately 4% weight (based on 100% PP) and a melting point of 160° C.; and a melt flow index of 3.3 g/10 min at 230° C. and a load of 2.16 kg (DIN 53 735) and

Second Cover Layer (2.0 μm)

99.7% by weight of ethylene-propylene copolymer with an proportion of ethylene of 4% by weight (based on the copolymer) and a melting point of 136° C.; and a melt flow index of 7.3 g/10 min at 230° C. and a load 2.16 kg (DIN 53 735) and a fusion enthalpy of 64.7 J/g.

0.3% by weight of antiblocking agent with an average particle diameter of approximately 4 μm (Sylobloc 45).

All layers of film additionally contained stabiliser and neutralising agent in the usual quantities.

In detail, the following conditions and temperatures were chosen during the manufacture of the film:

Extrusion: extrusion temperature approximately 250-270° C.

Chill roll: temperature 30° C.

Longitudinal stretching: T=125° C.

Longitudinal stretching by a factor of 5.

Transverse stretching: T=165° C.

Transverse stretching by the factor of 9.

Heat setting T—143° C.

The film was surface treated by corona on the surface of the first cover layer and exhibited a surface tension of 38 mN/m. The film had a thickness of 17 μm.

### EXAMPLE 2

A film was produced according to example 1. In contrast to example 1, a first intermediate layer with a thickness of 4 μm was inserted between the base layer and the first cover layer. In addition, the thickness of the first cover layer of 4 μm was reduced to 1.5 μm such that a total thickness of the first cover layer and the first intermediate layer of 5.5 μm was the result:

First Intermediate Layer (4 μm)

100% by weight of ethylene-propylene copolymer with a proportion of ethylene of 1.7% by weight (based on the copolymer) and a melting point of 155° C.; and a melt flow index of 8.5 g/10 min at 230° C. and a load of 2.16 kg (DIN 53 735) and a fusion enthalpy of 96.9 J/g.

The composition of the other layers corresponds to example 1.

### REFERENCE EXAMPLE 1

A transparent film was produced according to example 1. In contrast to example 1, the thickness of the first cover layer was only 0.5 μm. The total thickness of the film was 17 μm.

### COMPARATIVE EXAMPLE 2

A film was produced according to example 1. In contrast to example 1, the composition of the first cover layer was changed.

First Cover Layer (4 μm)

100% by weight of ethylene-propylene copolymer with a proportion of ethylene of 4% by weight (based on the copolymer) and a melting point of 136° C.; and a melt flow index of 7.3 g/10 min at 230° C. and a load of 2.16 kg (DIN 53 735) and a fusion enthalpy of 64.7 J/g.

All films according to the examples and the reference examples were coated in a vacuum metallising facility on the surface of the first cover layer with a layer of aluminium. To improve the adhesion of the metal, the surface was subjected to a plasma treatment immediately before coating. The properties of the metallised films according to the examples and the comparative examples are compiled in Table 1. It is apparent that the films according to the invention according to examples 1, 2 and 3 have excellent barrier values against water vapour and oxygen.

TABLE 1

| | Thickness | | | | |
|---|---|---|---|---|---|
| | of the | Thickness of | Raw material | | |
| | metallised | the | of the | WDD | OTR |
| | cover | intermediate | metallised | 38° C. | 23° C. |
| Example | layer μm | layer | layer | 90%* | 50%* |
| Example 1 | 4 | 0 | minicopo | <0.2 | −10 |
| Example 2 | 1.5 | 4 | minicopo | <0.2 | −15 |
| VB 1 | 0.8 | 0 | minicopo | <0.3 | −30 |
| VB 2 | 4 | 0 | Standard | <0.4 | −60 |
| | | | copo | | |

*after metallising

1-15. (canceled)

16. A metallized, biaxially oriented, transparent polypropylene multi-layer film which comprises at least two layers, wherein the layers comprise a base layer and at least one first metallized cover layer on a surface of the base layer wherein the layer contains at least 80% by weight of a propylene-ethylene copolymer which has an ethylene content of 1.2 to <2.8% by weight and a propylene content of 97.2-98.8% by weight and a melting point in the region of 140 to 160° C. and a fusion enthalpy of 80 to 110 J/g and the first cover layer has a thickness of at least 2.5 μm and the film is metallized on the surface of the first cover layer.

17. A metallized, biaxially oriented, transparent polypropylene multi-layer film which comprises at least three layers, wherein the layers comprise a base layer and at least one first intermediate layer and a first cover layer wherein the first cover layer and the first intermediate layer are placed on top of each other and contain at least 80% by weight of propylene-ethylene copolymer respectively which has an ethylene content of 1.2 to <2.8% by weight and a propylene content of 97.2 98.8% by weight and a melting point in the region of 140 to 160° C. and a fusion enthalpy of 80 to 110 J/g and the first cover layer has a thickness of 0.5-2 μm and the first intermediate layer a thickness of at least 2.0 μm and the film is metallized on the surface of the first cover layer.

18. The film according to claim 16, wherein the propylene-ethylene copolymer contains 1.5 to 2.5% by weight of ethylene and has a melting point in the region of 145 to 155° C. and a fusion enthalpy of 90 to 100 J/g.

19. The film according to claim 17, wherein the propylene-ethylene copolymer contains 1.5 to 2.5% by weight of ethylene and has a melting point in the region of 145 to 155° C. and a fusion enthalpy of 90 to 100 J/g.

20. The film according to claim 16, wherein the first cover layer contains no antiblocking agent.

21. The film according to claim 17, wherein the first cover layer contains no antiblocking agent.

22. The film according to claim 16, wherein the base layer is built up of propylene homopolymer.

23. The film according to claim 17, wherein the base layer is built up of propylene homopolymer.

24. The film according to claim 17, wherein the film exhibits, on the opposite side, a second, sealable cover layer with at least 80 to <100% by weight of a propylene polymer with at least 80% by weight propylene units.

25. The film according to claim 16, wherein the propylene polymer is a propylene copolymer and/or propylene terpolymer with a propylene content of at 90 to 97% by weight.

26. The film according to claim 16, wherein the second cover layer contains an antiblocking agent.

27. The film according to claim 17, wherein the propylene polymer is a propylene copolymer and/or propylene terpolymer with a propylene content of at 90 to 97% by weight.

28. The film according to claim 17, wherein the second cover layer contains an antiblocking agent.

29. A process for the production of a film claim 16, which comprises coextruding polyolefinic layers.

30. The process according to claim 29, wherein the film is pretreated on the surface of the first cover layer during film production by corona, plasma or flame.

31. The process according to claim 30, wherein the surface to be metallized is plasma treated immediately before metallizing.

32. A bag packing which comprises the film according to claim 16.

33. A process for laminating a film which comprises laminating the film according to claim 16 which comprises laminating the metallized side against a further film.
